(19) United States
(12) Patent Application Publication
(10) Pub. No.: US 2026/0184388 A1
(43) Pub. Date: Jul. 2, 2026

(54) WIND FRICTION REDUCTION DEVICE

(71) Applicant: Erik Johnson, Anchor Point, AK (US)

(72) Inventor: Erik Johnson, Anchor Point, AK (US)

(21) Appl. No.: 19/008,153

(22) Filed: Jan. 2, 2025

(51) Int. Cl. B62D 35/00; B62D 27/02; B62D 27/06

(52) U.S. Cl. CPC B62D 35/00; B62D 27/026; B62D 27/06

(57) ABSTRACT

A wind friction reduction device for enhancing aerodynamics of a vehicle includes a vehicle which has a plurality of body panels distributed around the vehicle. A plurality of aerodynamic panels is provided and each aerodynamic panel of the plurality of aerodynamic panels is attachable to a respective one of the plurality of body panels of the vehicle. Each aerodynamic panel of the plurality of aerodynamic panels has a plurality of dimples which reduce drag produced by air moving over the plurality of aerodynamic panels when the vehicle is being driven. A plurality of couplers is each attached to a respective one of the plurality of aerodynamic panels removably retaining the plurality of aerodynamic panels on the body panels of the vehicle.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to friction reduction devices and more particularly pertains to a new friction reduction device for enhancing aerodynamics of a vehicle. The device includes a vehicle which as a plurality of body panels and a plurality of aerodynamic panels which each has a plurality of dimples integrated into a respective aerodynamic panel. The device includes a plurality of couplers which is each attached to a respective aerodynamic panel and each coupler releasably engages a respective body panel to retain the respective aerodynamic panel on the respective body panel.

### (2) Description of Related Art including information disclosed under 37 CFR 1.97 and 1.98

The prior art relates to friction reduction devices including: a drag reducing surface depression device that includes a body which has a plurality of symmetrical depressions which are sized in proportion to dimensions of the body for reducing drag on the body; a friction reducing surface device which includes a vehicle which has a matrix of dimples formed into an improved surface of the vehicle for reducing drag on the vehicle; a variety of drag reducing devices that each at least includes a vehicle and a plurality of drag reduction elements which are each attachable to the vehicle at various locations on the vehicle to alter the flow of air over and around the vehicle to reduce drag on the vehicle; a drag reduction system which includes a semi trailer and a plurality of dimpled panels which are each attachable to the semi trailer for reducing drag on the semi trailer. In no instance does the prior art disclose a wind friction reduction device that includes a vehicle with body panels that define a shape of the vehicle and a plurality of aerodynamic panels which are each attachable to a respective body panel which each has a plurality of dimples for improving aerodynamics of the plurality of aerodynamic panels and a plurality of couplers attached to a respective aerodynamic panel for retaining the aerodynamic panels on the body panels.

### BRIEF SUMMARY OF THE INVENTION

An embodiment of the disclosure meets the needs presented above by generally comprising a vehicle which has a plurality of body panels distributed around the vehicle. A plurality of aerodynamic panels is provided and each aerodynamic panel of the plurality of aerodynamic panels is attachable to a respective one of the plurality of body panels of the vehicle. Each aerodynamic panel of the plurality of aerodynamic panels has a plurality of dimples which reduce drag produced by air moving over the plurality of aerodynamic panels when the vehicle is being driven. A plurality of couplers is each attached to a respective one of the plurality of aerodynamic panels removably retaining the plurality of aerodynamic panels on the body panels of the vehicle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective in-use view of a wind friction reduction device according to an embodiment of the disclosure.

FIG. 2 is a top view of an aerodynamic panel of an embodiment of the disclosure.

FIG. 3 is a magnified detail view taken from circle 3 of FIG. 2 of an embodiment of the disclosure.

FIG. 4 is a cross sectional view taken along line 4-4 of FIG. 2 of an embodiment of the disclosure.

FIG. 5 is a left side in-use view of an embodiment of the disclosure.

FIG. 6 is a magnified detail view taken from circle 6 of FIG. 4 of an embodiment of the disclosure.

### DETAILED DESCRIPTION OF THE INVENTION

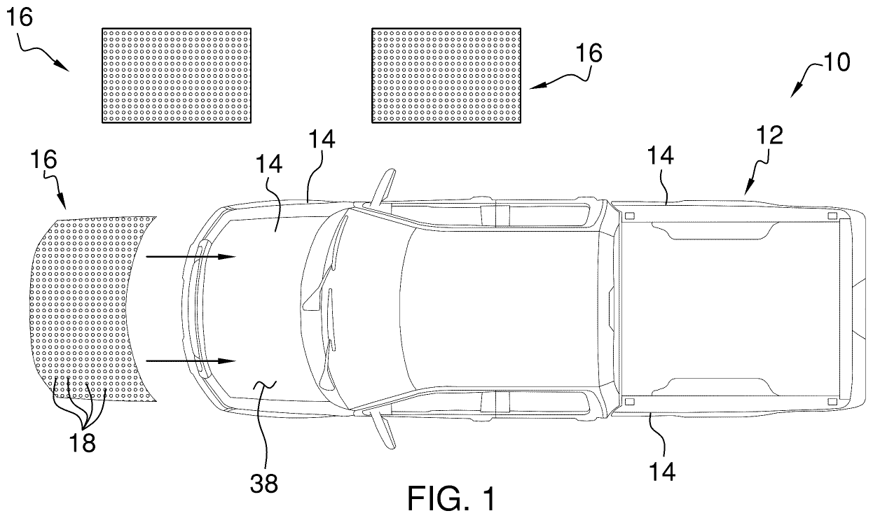

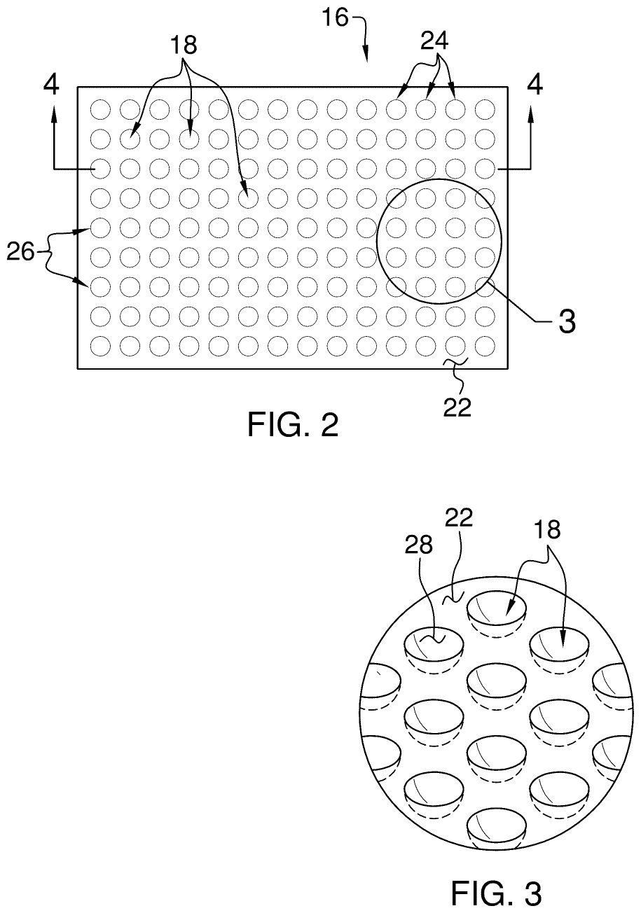

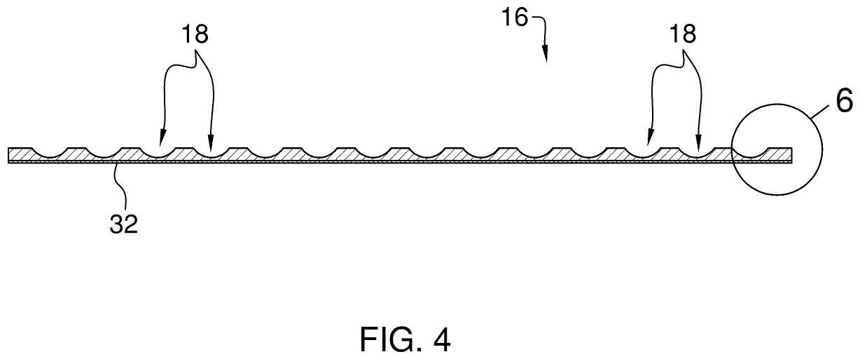

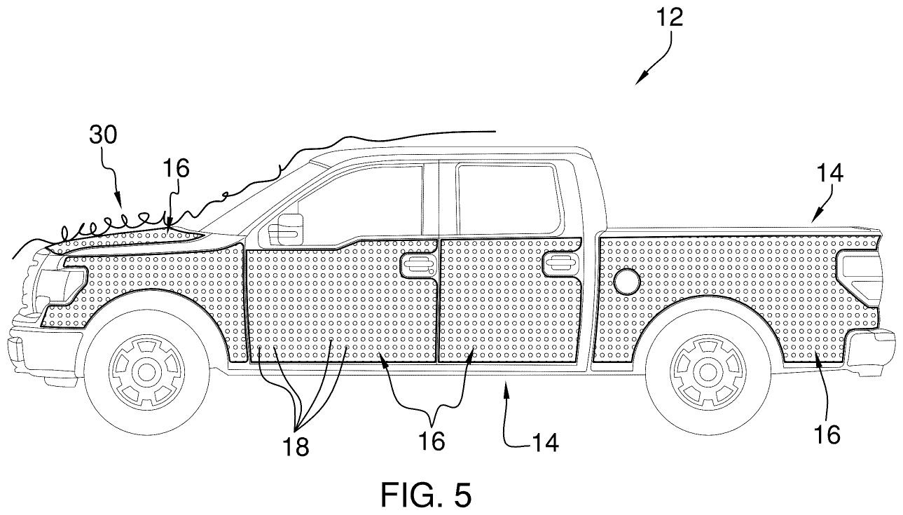

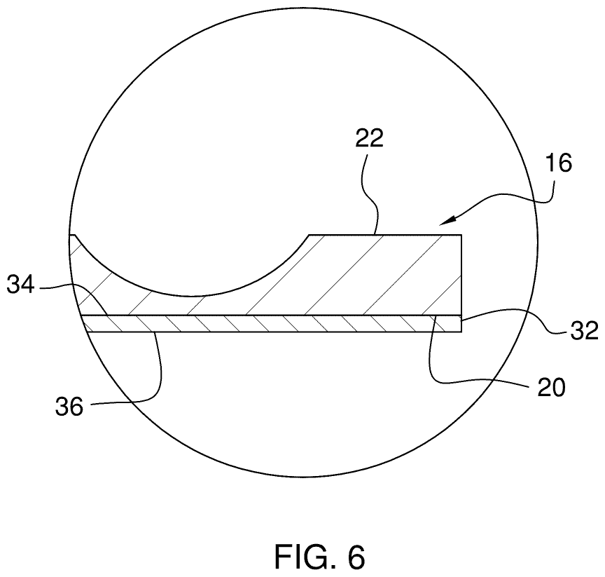

With reference now to the drawings, and in particular to FIGS. 1 through 6 thereof, a new friction reduction device embodying the principles and concepts of an embodiment of the disclosure and generally designated by the reference numeral 10 will be described.

As best illustrated in FIGS. 1 through 6, the wind friction reduction device 10 generally comprises a vehicle 12 that has a plurality of body panels 14 distributed around the vehicle 12 such that the body panels 14 define a shape of the vehicle 12. The vehicle 12 may comprise a passenger vehicle, a cargo vehicle or any other type of motorized vehicle 12 that is driven on public roadways. A plurality of aerodynamic panels 16 is provided and each aerodynamic panel 16 of the plurality of aerodynamic panels 16 is attachable to a respective one of the plurality of body panels 14 of the vehicle 12. Furthermore, the plurality of aerodynamic panels 16 completely cover the plurality of body panels 14. Each aerodynamic panel 16 of the plurality of aerodynamic panels 16 has a plurality of dimples 18 integrated into a respective aerodynamic panel 16. Furthermore, each dimple 18 of the plurality of dimples 18 reduces drag produced by air moving over the plurality of aerodynamic panels 16 when the vehicle 12 is being driven such that a fuel economy of the vehicle 12 is improved.

Each aerodynamic panel 16 of the plurality of aerodynamic panels 16 has a bottom surface 20 and a top surface 22. Furthermore, each dimple 18 of the plurality of dimples 18 associated with a respective aerodynamic panel 16 is recessed into the top surface 22 of the respective aerodynamic panel 16. The plurality of dimples 18 associated with the respective aerodynamic panel 16 is arranged in a plurality of columns 24 and rows 26 on the top surface 22 of the respective aerodynamic panel 16. Each dimple 18 of the plurality of dimples 18 has a bounding surface 28 which is concavely arcuate with respect to the top surface 22 of the respective aerodynamic panel 16 such that each dimple 18 of the plurality of dimples 18 defines a hemispherical shape. Moreover, the bounding surface 28 of each dimple 18 of the plurality of dimples 18 associated with the respective aerodynamic panel 16 creates a turbulent boundary of air 30 which flows along the top surface 22 of the respective aerodynamic panel 16 when the vehicle 12 is moving thereby reducing drag on the top surface 22 of the respective aerodynamic panel 16.

Each aerodynamic panel 16 of the plurality of aerodynamic panels 16 is comprised of a transparent material, including but not being limited to plastic or silicone, such that each aerodynamic panel 16 of the plurality of aerodynamic panels 16 can pass light through the plurality of aerodynamic panels 16 thereby enabling a color of a paint on the plurality of body panels 14 of the vehicle 12 to be visible through the plurality of aerodynamic panels 16. Furthermore, the transparent material of which each of the aerodynamic panels 16 is comprised may comprise a rigid material such that each aerodynamic panel 16 of the plurality of aerodynamic panels 16 can protect the plurality of body panels 14 of the vehicle 12 from impact damage. Each aerodynamic panel 16 of the plurality of aerodynamic panels 16 is cut to a shape which matches a shape of the respective body panel 14 upon which each aerodynamic panel 16 of the plurality of aerodynamic panels 16 is to be positioned.

A plurality of couplers 32 is provided and each coupler 32 the plurality of couplers 32 is attached to a respective one of the plurality of aerodynamic panels 16. Each coupler 32 the plurality of couplers 32 releasably engages a respective one of the plurality of body panels 14 of the vehicle 12 for removably retaining the plurality of aerodynamic panels 16 on the body panels 14 of the vehicle 12. Each coupler 32 the plurality of couplers 32 has a coupled surface 34 which is coupled to the bottom surface 20 of the respective aerodynamic panel 16 having the coupled surface 34 of a respective one of the plurality of couplers 32 completely covering the bottom surface 20 of the respective aerodynamic panel 16. Each coupler 32 the plurality of couplers 32 has an exposed surface 36 and the exposed surface 36 of each coupler 32 the plurality of couplers 32 abuts an exterior surface 38 of the respective body panel 14 of the vehicle 12.

The exposed surface 36 of each coupler 32 the plurality of couplers 32 releasably engages the exterior surface 38 of the respective body panel 14 to retain each aerodynamic panel 16 of the plurality of aerodynamic panels 16 on the exterior surface 38 of the respective body panel 14. Each coupler 32 the plurality of couplers 32 may comprise a magnetic material such that the exposed surface 36 of each coupler 32 the plurality of couplers 32 can magnetically engage the respective body panel 14 when the respective body panel 14 is comprised of a ferromagnetic material. The magnetic material may be a flexible magnetic material which is comprised a mixture of a ferrite powder and a rubber polymer resin such that the exposed surface 36 of each coupler 32 the plurality of couplers 32 can conform to contours of the exterior surface 38 of the respective body panel 14. Alternatively, each coupler 32 the plurality of couplers 32 may be comprised of an adhesive material such that the exposed surface 36 of each coupler 32 the plurality of couplers 32 can adhesively engage the respective body panel 14 when the respective body panel 14 is not comprised of a ferromagnetic material.

In use, a respective aerodynamic panel 16 is cut to a shape which matches a shape of the respective body panel 14 of the vehicle 12 upon which the respective aerodynamic panel 16 is to be positioned. The coupler 32 on the respective aerodynamic panel 16 is placed against the respective body panel 14 while the respective aerodynamic panel 16 is oriented to be aligned with the respective body panel 14. The process of cutting and attaching each of the plurality of aerodynamic panels 16 is repeated unit all of the body panels 14 of the vehicle 12 are covered with the plurality of aerodynamic panels 16. The plurality of dimples 18 in each of the plurality of aerodynamic panels 16 creates the turbulent boundary of air 30 which flows over the plurality of aerodynamic panels 16 when the vehicle 12 is being driven. Furthermore, the turbulent boundary of air 30 reduces drag of the air on each of the plurality of aerodynamic panels 16 thereby enhancing the fuel economy of the vehicle 12 as well as prolonging the service life of the engine and drivetrain of the vehicle 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A wind friction reduction device comprising:
a vehicle having a plurality of body panels being distributed around said vehicle such that said plurality of body panels defines a shape of said vehicle;
a plurality of aerodynamic panels, each aerodynamic panel of said plurality of aerodynamic panels being attachable to a respective one of said plurality of body panels of said vehicle such that said plurality of aerodynamic panels completely covers said plurality of body panels, each aerodynamic panel of said plurality of aerodynamic panels having a plurality of dimples being integrated into a respective aerodynamic panel wherein each dimple of said plurality of dimples is configured reduce drag produced by air moving over said respective aerodynamic panel when said vehicle is being driven such that a fuel economy of said vehicle is improved; and
a plurality of couplers, each coupler of said plurality of couplers being attached to a respective one of said plurality of aerodynamic panels, each coupler of said plurality of couplers releasably engaging a respective one of said plurality of body panels of said vehicle for removably retaining said plurality of aerodynamic panels on said body panels of said vehicle.

2. The wind friction reduction device according to claim 1, wherein:
each aerodynamic panel of said plurality of aerodynamic panels has a bottom surface and a top surface;
each dimple of said plurality of dimples associated with a respective aerodynamic panel is recessed into said top surface of said respective aerodynamic panel; and
said plurality of dimples associated with said respective aerodynamic panel is arranged in a plurality of columns and rows on said top surface of said respective aerodynamic panel.

3. The wind friction reduction device according to claim 2, wherein each dimple of said plurality of dimples has a bounding surface being concavely arcuate with respect to said top surface of said respective aerodynamic panel such that each dimple of said plurality of dimples defines a hemispherical shape wherein said bounding surface of each dimple of said plurality of dimples associated with said respective aerodynamic panel is configured to create a turbulent boundary of air which flows along said top surface of said respective aerodynamic panel when said vehicle is moving thereby reducing drag on said top surface of said respective aerodynamic panel.

4. The wind friction reduction device according to claim 1, wherein each aerodynamic panel of said plurality of aerodynamic panels is comprised of a transparent material wherein each aerodynamic panel of said plurality of aerodynamic panels is configured to pass light through said plurality of aerodynamic panels such that a color of a paint on said plurality of body panels of said vehicle is visible through said plurality of aerodynamic panels.

5. The wind friction reduction device according to claim 1, wherein each coupler of said plurality of couplers has a coupled surface being coupled to a bottom surface of said respective aerodynamic panel having said coupled surface of a respective one of said plurality of couplers completely covering said bottom surface of said respective aerodynamic panel.

6. The wind friction reduction device according to claim 1, wherein:
each coupler of said plurality of couplers has an exposed surface; and
said exposed surface of each coupler of said plurality of couplers abuts an exterior surface of said respective body panel of said vehicle.

7. The wind friction reduction device according to claim 6, wherein said exposed surface of each coupler of said plurality of couplers releasably engages said exterior surface of said respective body panel to retain each aerodynamic panel of said plurality of aerodynamic panels on said exterior surface of said respective body panel.

8. A wind friction reduction device comprising:
a vehicle having a plurality of body panels being distributed around said vehicle such that said plurality of body panels defines a shape of said vehicle;
a plurality of aerodynamic panels, each aerodynamic panel of said plurality of aerodynamic panels being attachable to a respective one of said plurality of body panels of said vehicle such that said plurality of aerodynamic panels completely covers said plurality of body panels, each aerodynamic panel of said plurality of aerodynamic panels having a plurality of dimples being integrated into a respective aerodynamic panel wherein each dimple of said plurality of dimples is configured reduce drag produced by air moving over said respective aerodynamic panel when said vehicle is being driven such that a fuel economy of said vehicle is improved, each aerodynamic panel of said plurality of aerodynamic panels having a bottom surface and a top surface, each dimple of said plurality of dimples associated with a respective aerodynamic panel being recessed into said top surface of said respective aerodynamic panel, said plurality of dimples associated with said respective aerodynamic panel being arranged in a plurality of columns and rows on said top surface of said respective aerodynamic panel, each dimple of said plurality of dimples having a bounding surface being concavely arcuate with respect to said top surface of said respective aerodynamic panel such that each dimple of said plurality of dimples defines a hemispherical shape wherein said bounding surface of each dimple of said plurality of dimples associated with said respective aerodynamic panel is configured to create a turbulent boundary of air which flows along said top surface of said respective aerodynamic panel when said vehicle is moving thereby reducing drag on said top surface of said respective aerodynamic panel, each aerodynamic panel of said plurality of aerodynamic panels being comprised of a transparent material wherein each aerodynamic panel of said plurality of aerodynamic panels is configured to pass light through said plurality of aerodynamic panels such that a color of a paint on said plurality of body panels of said vehicle is visible through said plurality of aerodynamic panels; and
a plurality of couplers, each coupler of said plurality of couplers being attached to a respective one of said plurality of aerodynamic panels, each coupler of said plurality of couplers releasably engaging a respective one of said plurality of body panels of said vehicle for removably retaining said plurality of aerodynamic panels on said body panels of said vehicle, each coupler of said plurality of couplers having a coupled surface being coupled to said bottom surface of said respective aerodynamic panel having said coupled surface of a respective one of said plurality of couplers completely covering said bottom surface of said respective aerodynamic panel, each coupler of said plurality of couplers having an exposed surface, said exposed surface of each coupler of said plurality of couplers abutting an exterior surface of said respective body panel of said vehicle, said exposed surface of each coupler of said plurality of couplers releasably engaging said exterior surface of said respective body panel to retain each aerodynamic panel of said plurality of aerodynamic panels on said exterior surface of said respective body panel.

9. The wind friction reduction device according to claim 8, wherein each coupler of said plurality of couplers comprises a magnetic material such that each coupler of said plurality of couplers can magnetically engage said respective body panel when said respective body panel is comprised of a ferromagnetic material.

10. The wind friction reduction device according to claim 9, wherein said magnetic material comprises a flexible magnetic material such that said exposed surface of each of said plurality of couplers can conform to contours of exterior surface of said respective body panel.

11. The wind friction reduction device according to claim 8, wherein each coupler of said plurality of couplers comprises an adhesive material such that said exposed surface of each coupler of said plurality of couplers can adhesively engage said exposed surface of said respective body panel when said respective body panel is not comprised of a ferromagnetic material.
